(19) United States
(12) Patent Application Publication
(10) Pub. No.: US 2026/0087287 A1
(43) Pub. Date: Mar. 26, 2026

(54) Optically Transmissive Seal

(71) Applicant: Zebra Technologies Corporation, Lincolnshire, IL (US)

(72) Inventors: Igor Naroditsky, Massapequa, NY (US); Roland Wing Fai Lee, Jericho, NY (US)

(21) Appl. No.: 18/895,949

(22) Filed: Sep. 25, 2024

(51) Int. Cl. G06K 7/10

(52) U.S. Cl. CPC G06K 7/10881

(57) ABSTRACT

Optically transmissive seals are provided herein. An example image-based data capture device includes a housing, an imaging assembly configured to capture image data, a processing device configured to extract payload data from the image data, and an indicator assembly which includes a light source and an optically transmissive environmental seal in communication with the light source of the indicator assembly, where responsive to a successful decode of an indicia by the processing device, the indicator assembly triggers the light source to output an optical indication through the optically transmissive seal such that the optical indication is externally visible relative to the housing.

### BACKGROUND

When designing a device, there is often a requirement to seal a housing of the device to prevent ingress of particulate matter, water, and/or other substances. This type of product specification or requirement is often achieved with a component disposed between sections of a housing of the device such that any resulting gaps in the housing are filled. Another common feature of devices is the presence of one or more indicator lights indicative of a status of the device, which are often transmitted through a device housing by a transparent window of the housing.

### SUMMARY

Devices are provided herein for providing a housing seal which transmits light.

In an example embodiment, the present invention is an imaging-based data capture device, comprising a housing, an imaging assembly configured to capture image data, a processing device configured to extract payload data from the image data, and an indicator assembly which includes a light source and an optically transmissive environmental seal in communication with the light source of the indicator assembly, where responsive to a successful decode of an indicia by the processing device, the indicator assembly triggers the light source to output an optical indication through the optically transmissive seal such that the optical indication is externally visible relative to the housing.

In a variation of this example embodiment, the imaging-based data capture device has a handle portion and a head portion and the indicator assembly is located in the head portion.

In a variation of this example embodiment, the optically transmissive seal complies with an ingress protection 54 (IP54) rating.

In a variation of this example embodiment, the optically transmissive seal has a Shore A hardness of 60 or less.

In a variation of this example embodiment, the optically transmissive seal has a Shore A hardness of between 35 and 45.

In a variation of this example embodiment, a ridge of the housing engages with a first groove of the optically transmissive seal.

In a variation of this example embodiment, the imaging-based data capture device includes a transparent cover over the optically transmissive seal.

In a variation of this example embodiment, a ridge of the transparent cover engages with a second groove of the optically transmissive seal.

In a variation of this example embodiment, the optically transmissive seal is translucent.

In a variation of this example embodiment, the light source is capable of emitting light of two or more distinct colors.

In a variation of this example embodiment, the optically transmissive seal is made from silicone or rubber.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example imaging-based data capture device, according to example embodiments of the present disclosure.

FIG. 2 illustrates an example head portion of a housing with an optically transmissive seal, according to example embodiments of the present disclosure.

FIG. 3 illustrates an example section view of a housing, an optically transmissive seal, and a light source, according to example embodiments of the present disclosure.

FIG. 4A illustrates a first example section of an upper housing, a lower housing, and an optically transmissive seal, according to example embodiments of the present disclosure.

FIG. 4B illustrates a second example section of an upper housing, a lower housing, and an optically transmissive seal, according to example embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Devices are provided herein for providing a housing seal which transmits light. In many device development and design settings, miniaturization and reduction of complexity are of a high priority. Significant resources are dedicated to reducing a size of a device during a design process, especially when the device is expected to be handheld, as is often the case with imaging-based data capture devices such as indicia decoders.

Most electronic devices are sensitive to the ingress of dust, water, and other substances to some degree, and therefore many of these devices provide some form of isolation of an internal cavity which contains sensitive components from an external environment. Many of these devices also provide one or more indicator lights configured to transmit optical signals through a housing of the device, usually via a transparent or translucent hard plastic or glass window integrated into the housing. Designing device geometries to accommodate these lights can involve significant effort, and often necessitates computationally intensive processes such as ray tracing to ensure that a proper quantity of light is transmitted from a light source (usually mounted to a circuit board within a device) to an exterior of the device. It will be apparent to those of skill in the art that a reduction of this complexity in both the design process and in the device itself would be desirable so as to reduce human and computational resource usage during design and complexity during manufacturing, and thus improve a robustness of the device by reducing a part count.

Embodiments of the present disclosure advantageously dispose of the optically transmissive windows found in existing devices by shifting this function into the seal. By fashioning the seal out of optically transmissive materials, significant reductions can be achieved in device and design complexity. Less apparent, however, is that this approach to implementing an indicator light avoids the computationally intensive ray tracing process by facilitating transmission of light in paths that are not line-of-sight. These benefits mean that both design and manufacturing of a device can be streamlined advantageously in ways that will be immediately apparent to those skilled in the art.

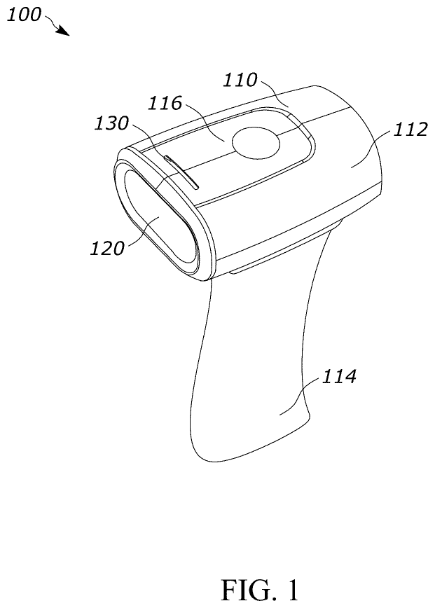

FIG. 1 illustrates an example imaging-based data capture device 100, according to example embodiments of the present disclosure. In this example, a housing 110 of the imaging-based data capture device 100 may include a head portion 112 and a handle portion 114. It will be appreciated that although the imaging-based data capture device 100 is illustrated herein as a handheld barcode scanner, the imaging-based data capture device 100 may be any device capable of capturing and processing image data to extract payload data contained therein, including non-portable devices such as checkout kiosks. It will also be contemplated that embodiments of the present disclosure, even those which are intended to be handheld, may take differing forms to that which is illustrated, including those that do not include a distinct head portion 112 and/or a distinct handle portion 114. For example, the image-based data capture device 100 may be a tablet or handheld computer.

Continuing the illustrated example, the imaging-based data capture device 100 may be configured to collect image data through a viewing window 120 integrated into the head portion 112 of the housing 110. The head portion 112 may also include a separately fashioned component 116 that may, for example, be of a differing material, color, transparency, translucency, and/or any other characteristic from that of a remainder of the head portion 112. The housing 110 may include an indicator light assembly 130 configured to convey a state of the image-based data capture device 100 to a user.

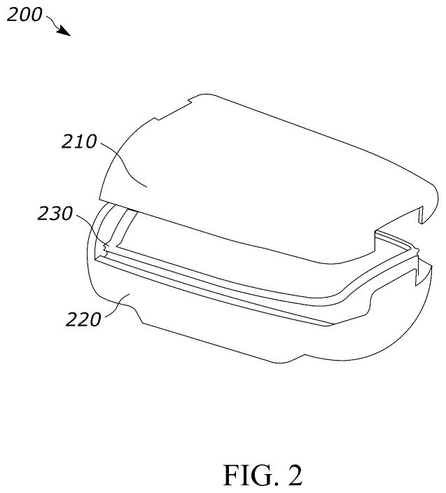

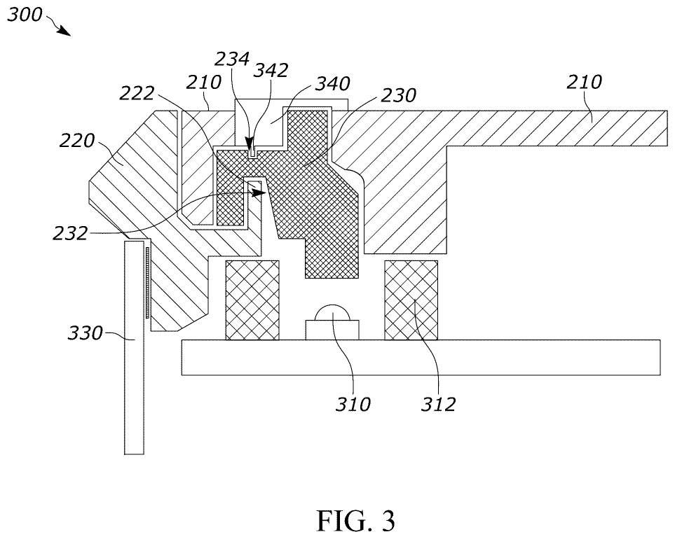

The indicator light assembly 130 may be provided via a light source (see FIG. 3) employing any known technique for producing an optical signal which is electronically controllable, including but not limited to light emitting diodes (LEDs), incandescent light sources, arcing light sources, pyrotechnic light sources, and any other types of light source. Light from a source of the indicator light assembly 130 may be transmitted from a location of the source to an exterior of the housing 110 by an optically transmissive seal (see FIG. 2) which serves a second purpose of preventing ingress of particulates, water, and/or other substances into the housing 110. Optical signals of the indicator light assembly 130 may be directly transmitted through the seal, or may be conducted to the seal from the source via another intermediary medium. For example, light from the source may be transmitted via one or more optical fibers from a location of the source to an interior of the seal. Though illustrated with an exterior interface on a dorsal surface of the head portion 112 of the housing 110, the exterior interface of indicator light assembly 130 may be positioned anywhere else on the housing 110.

It will be appreciated that the indicator light assembly 130 may be capable of producing optical signals in more than one color. For example, the indicator light assembly 130 may be capable of producing red light to indicate a first state of the image-based data capture device 100, for example a ready state, and to produce green light to indicate a second state of the image-based data capture device 100, for example a successful decode of an indicium. It will also be appreciated that the indicator light assembly 130 may include one or more light sources capable of producing a full range of colors which may be user-configurable. For example, the indicator light assembly 130 may include red, green, and blue light sources to allow a user or software of the image-based data capture device 100 to vary relative ratios of these three colors and therefore produce any perceived color of light desired.

FIG. 2 illustrates an example head portion 200 of a housing with an optically transmissive seal 230, according to example embodiments of the present disclosure. In this example, the head portion 200 includes an upper shell 210 and a lower shell 220. The upper shell 210 and the lower shell 220 may be mechanically mated with any temporary or permanent technique including but not limited to screws, rivets, plastic welds, adhesives, clamps, snap fits, and tabs.

A seal 230 may be disposed along a joint between the upper shell 210 and the lower shell 220 such that the seal 230 prevents movement of particulate matter, water, and/or other matter through the joint. In some embodiments, the seal 230 may be sufficient to comply with an ingress protection 54 (IP54) rating as defined by the European Committee for Electrotechnical Standardization (CENELEC) in the publication IEC 60529—Degrees of protection provided by enclosures (IP Code) 2.2 ed. (ISBN 9782832210864). The seal 230 may also comply with a greater or lesser degree of ingress prevention. The seal 230 may be optically transmissive, that is to say the seal 230 may be capable of conveying optical indications from a light source within the head portion 200 such that optical indications are externally visible relative to a housing of the head portion 200. The seal 230 may be transparent, translucent, partially transparent, partially translucent, and combinations thereof.

In order to provide adequate ingress protection, the seal 230 may have a hardness measured on the Shore A hardness scale less than 60. For an IP54 rating, the seal 230 may, for example, possess a Shore A hardness between 35 and 45. This may be achieved by fashioning the seal 230 from any material which can achieve the necessary hardness characteristics, including but not limited to silicone, rubber, resin, epoxy, and plastic. The seal 230 may be configured to maintain ingress protection at temperatures which the device is expected to encounter, particularly but not limited to temperatures between −10 C and 100 C.

In some example embodiments, the upper shell 210 and/or the lower shell 220 may include one or more optically transmissive windows (see FIG. 3, cover 340) configured to make externally visible optical signals which are transmitted through the seal 230. In these embodiments, the seal 230 may be more or less fully enveloped by the upper shell 210 and the lower shell 220. The seal 230 may thus not include significant portions which are exposed to an external environment via a line-of-sight path which does not pass through the optically transmissive windows.

Some example embodiments may include additional elements of a housing of the head portion 200 beyond the upper shell 210 and the lower shell 220 (see FIG. 1, separately fashioned component 116). These additional elements may engage with the seal 230, and additional seals which may or may not be optically transmissive may be provided in connection with the additional elements.

FIG. 3 illustrates an example section view 300 of a housing, an optically transmissive seal 230, and a light source 310, according to example embodiments of the present disclosure. In this example, the housing may include an upper shell 210 and a lower shell 220. Disposed between the upper shell 210 and the lower shell 220 is an optically transmissive seal 230. A light source 310 is configured to cause an optical signal to enter the optically transmissive seal 230, thereby illuminating the optically transmissive seal 230 in a vicinity of the light source 310 and causing the optical signal to become visible externally relative to the housing. A viewing window 330 may allow imaging equipment (not illustrated) to view an external environment. A cowling 312 may contain optical signals from the light source 310 so as to reduce illumination from the light source 310 within a main cavity of the housing, where such illumination may interfere with the imaging equipment by, for example, causing a glare on the viewing window 330.

The transparent or translucent cover 340 may be provided over the optically transmissive seal 230. The cover 340 may be affixed to or integrated within the upper shell 210, or may be omitted altogether. A cover 340 may be particularly desirable when the seal 230 is fashioned from a material which tends to accumulate debris (e.g. some types of silicone) in order to prevent such accumulation. The cover 340 may be fashioned from any material capable of transmitting optical signals from the optically transmissive seal 230 to an external environment of the upper shell 210, including but not limited to plastic and glass.

A first ridge 222 of the lower shell 220 may engage with a first groove 232 in the optically transmissive seal 230. Likewise, a second ridge 342 of the cover 340 may engage with a second groove 234 in the optically transmissive seal 230. The first ridge 222 and the second ridge 342 may serve to strengthen an ingress protection provided by the optically transmissive seal 230 by forcing any would-be entrant materials to travel a longer path than they would otherwise be able to travel.

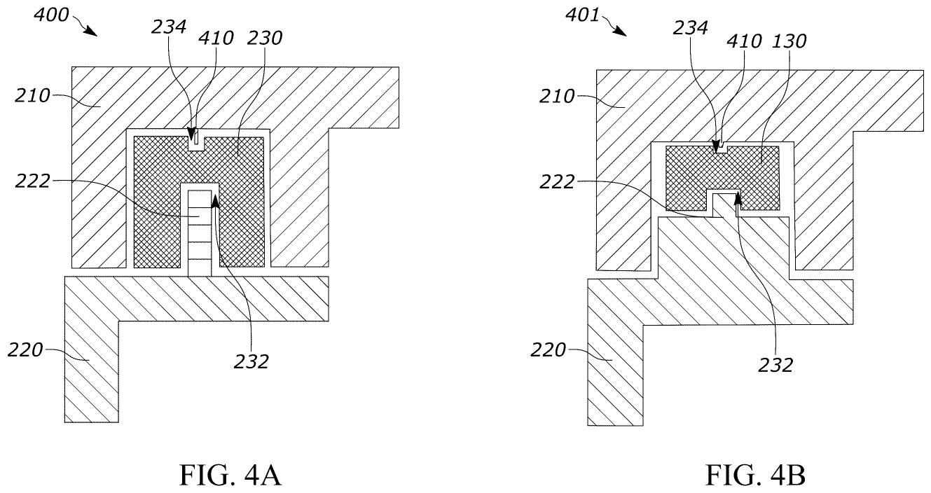

The section view 300 illustrates a vicinity of an indicator light assembly (see FIGS. 1, 130) and thus may not be representative of a section view taken elsewhere along the optically transmissive seal 230 (see FIG. 4 for examples). It will be appreciated that while one possible section view 300 is illustrated in FIG. 3, actual geometries may differ widely and are far too numerous to individually contemplate.

It will further be appreciated that example embodiments which omit a cover 340 may replace some of the illustrated cover's 340 geometry with portions of the upper shell 210. This is particularly true for the second ridge 342, which may in some embodiments be provided as a part of the upper shell 210 rather than the cover 340.

FIG. 4A illustrates a first of example section 400 of an upper shell 210, a lower shell 220, and an optically transmissive seal 230, according to example embodiments of the present disclosure. FIG. 4B illustrates a second example section 401 of an upper shell 210, a lower shell 220, and an optically transmissive seal 230, according to example embodiments of the present disclosure. In both examples, the optically transmissive seal 230 is disposed between the upper shell 210 and the lower shell 220. The lower shell 220 includes a first ridge 222 which is configured to engage with a first groove 232 in the optically transmissive seal 230, thereby providing a secure seating for the optically transmissive seal 230 while also increasing a travel path required for ingress of matter. This arrangement is mirrored by the upper shell 210, which may include a second ridge 410 configured to engage with a second groove 234 in the optically transmissive seal 230.

The optically transmissive seal 230 is illustrated in FIG. 4A and FIG. 4B at two different sizes which will naturally consume differing amounts of material. Likewise, the first ridge 222 and the second ridge 410 are illustrated at sizes commensurate with a scaling of the optically transmissive seal 230. It will be appreciated that the first ridge 222 and the second ridge 410 may be implemented at the relative scales illustrated herein, or may be implemented at differing relative scales in both prominence and breadth. It will also be appreciated that some embodiments of the present disclosure may omit the first ridge 222 and/or the second ridge 410 along with the first groove 232 and/or the second groove 234, as appropriate.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device”can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging-based data capture device, comprising:
a housing having a lower portion and an upper portion;
an imaging assembly configured to capture image data;
a processing device configured to extract payload data from the image data; and
an indicator assembly which includes a light source and an optically transmissive environmental seal in communication with the light source of the indicator assembly, where responsive to a successful decode of an indicia by the processing device, the indicator assembly triggers the light source to output an optical indication through the optically transmissive seal such that the optical indication is externally visible relative to the housing,
wherein the optically transmissive environmental seal is disposed along a joint between the lower portion and the upper portion.

2. The imaging-based data capture device of claim 1, wherein the imaging-based data capture device has a handle portion and a head portion and the indicator assembly is located in the head portion.

3. The imaging-based data capture device of claim 1, wherein the optically transmissive seal complies with an ingress protection 54 (IP54) rating.

4. The imaging-based data capture device of claim 1, wherein the optically transmissive seal has a Shore A hardness of 60 or less.

5. The imaging-based data capture device of claim 51, wherein the optically transmissive seal has a Shore A hardness of between 35 and 45.

6. The imaging-based data capture device of claim 1, wherein a ridge of the housing engages with a first groove of the optically transmissive seal.

7. The imaging-based data capture device of claim 1, wherein the imaging-based data capture device includes a transparent cover over the optically transmissive seal.

8. The imaging-based data capture device of claim 7, wherein a ridge of the transparent cover engages with a second groove of the optically transmissive seal.

9. The imaging-based data capture device of claim 1, wherein the optically transmissive seal is translucent.

10. The imaging-based data capture device of claim 1, wherein the light source is capable of emitting light of two or more distinct colors.

11. The imaging-based data capture device of claim 1, wherein the optically transmissive seal is made from silicone or rubber.
